(19) United States
(12) Patent Application Publication
(10) Pub. No.: US 2013/0072329 A1
(43) Pub. Date: Mar. 21, 2013

(54) Self timed game

(71) Applicant: Carl D. Shoffner, Whitsett, NC (US)

(72) Inventor: Carl D. Shoffner, Whitsett, NC (US)

(21) Appl. No.: 13/200,217

(22) Filed: Sep. 21, 2011

(51) Int. Cl. A63B 67/00; G04F 10/00; A63B 71/06

(52) U.S. Cl. 473/465; 473/569; 368/3

(57) ABSTRACT

This is a timed dodge ball type game played by two or more players. Consisting of two or more balls preferable six balls numbered two threw seven. The adjective is to throw and hit one of the other player with one of the numbered ball resulting in that person dropping all of their number balls for the number of second on that ball thrown giving any of the players a chance to get the dropped ball. After that number of seconds labeled on that ball that hit that player is up, the player that dropped the ball can now pick up the remaining balls and rejoin the game. At the end of a preset stop time all player add up the number on the ball they are holding and the highest number wins.

### BACKGROUND

This invention relates to games of skill and has particular relationship to such games played with a ball or balls in a court or playground.

It is an object of this invention to provide such a game of skill in which people of substantially all ages, within reason, can take part, and which shall afford entertainment, help to develop coordination, strategy, and contribute to physical fitness.

It is also an object of this invention to provide such a game which shall impose, on the participating players, demands of skill of such wide variety that those who once participate in the game will continue to be interested in it.

### SUMMARY

In accordance with this invention a game is provided which is played with stuffed balls or the like on a court, ordinary home or in multiples on a playground or in a recreation hall or an athletic facility. An object of the game in one example is to throw and hit one of the other players with one of the numbered ball resulting in that person dropping all of their number balls for the number of seconds on that ball giving any of the other players a chance to get the dropped ball. After the time limit is up the player that dropped the ball can now pick up the remaining balls and rejoin the game. At the end of a preset time all player add up the number on the ball they are holding and the highest number wins. Games of this general type, in accordance with the teachings of the prior art, such as dodge ball and basketball, require a large playground and, in the case of basketball a large court, elaborate and costly equipment. It is an object of this invention to provide a game whose court shall be of relatively small dimensions so that the game can be played in the game room of an ordinary home or the like or a number of games can be played on a playground, in a recreation hall or athletic facility.

### BRIEF DISCRETION OF DRAWINGS

FIG. 1 shows a view of numbered balls according to an example.

FIG. 2 shows a view of colored balls according to an example.

FIG. 3 shows a view of colored balls with electronic counting modules according to an example.

FIG. 4 shows a view of an apparatus to be worn according to an example.

FIG. 5 shows a view of an apparatus to be worn according to an example.

### DETAIL DESCRIPTION

In the following description, the use of “a.” “an,” or “the” can refer to the plural. All

Examples given are for clarification only, and are not intended to limit the scope of the invention.

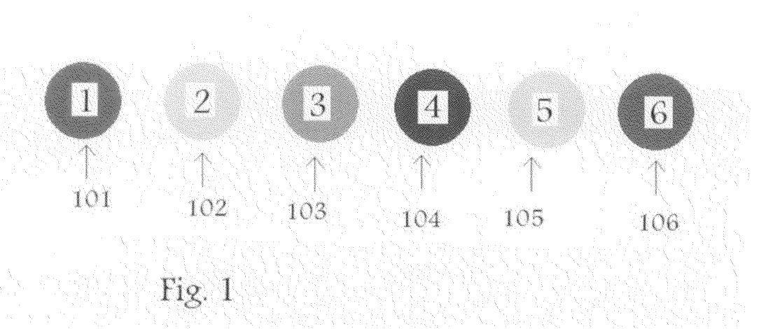

Referring now to FIG. 1 a self timed game 101, 102, 103, 104, 105, 106, which are the number of seconds to be counted before the balls can be reclaimed.

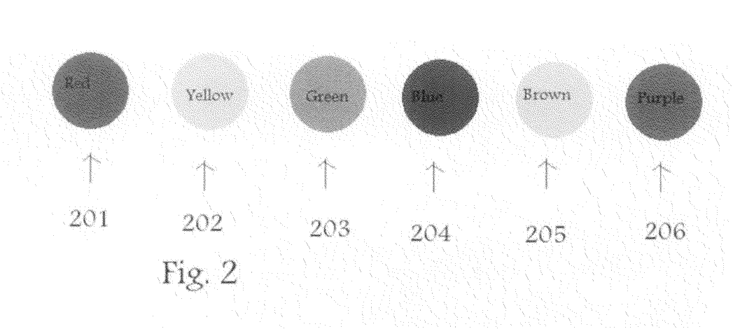

Referring now to FIG. 2 a self timed game 201, 202, 203, 204, 205, 206, which are the color that have to be spelled before the balls can be reclaimed.

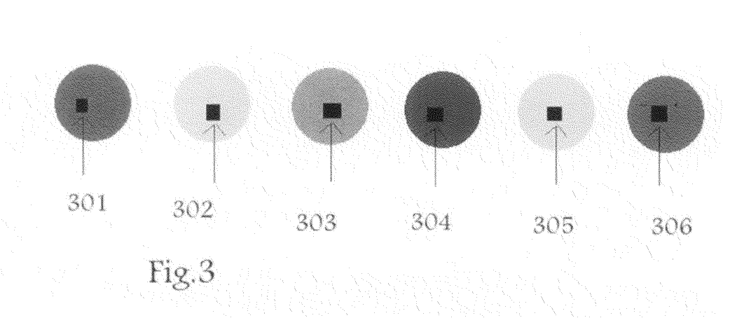

Referring now to FIG. 3 a self timed game 301, 302, 303, 304, 305, 306, which are the sound modules that will count the number of seconds before the balls can be reclaimed.

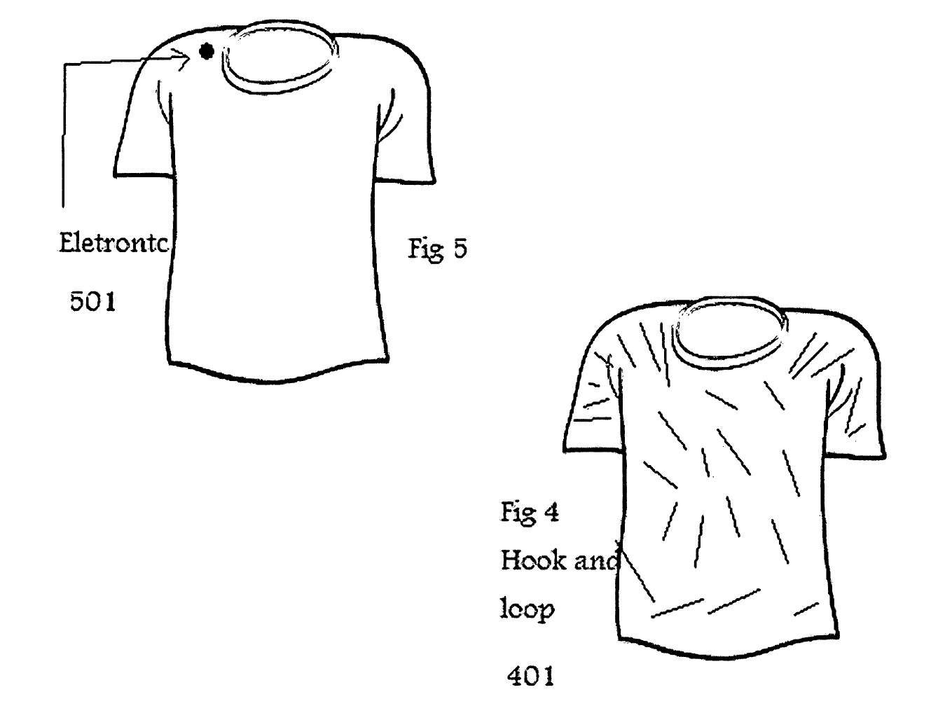

Referring now to FIG. 4 shows a view of an apparatus to be worn to a preferred embodiment with 401 a hook or loop configuration.

Referring now to FIG. 5 shows a view of an apparatus to be worn, to a preferred embodiment with 501 an electronic device.

What is claimed:

1. A self timed game comprising:
(a) At least two individual objects that are each labeled in its own way with when spoken will allow the passage of time.
(b) Wherein said object comprising a timing method.
(c) Wherein said timer may be and not limited to an electronic device.
(d) Wherein said timer may be any method of self timing but not limited to an electronic device to count the passage of time, or spelling the color name to count the passage of time, or counting out the number of seconds on the object to allow the passage of time.

2. A self timed game comprising:
(a) An apparatus to be worn on the player that will measure a period of time.
(b) Wherein the passage of time may be and electronic device that will determine the period of time.
(c) Wherein said apparatus may be a hook and loop apparatus.

3. A game comprising:
(a) Method of playing a game is to throw and hit one of the other player with one of the numbered projectile resulting in that person dropping all of their number projectile for the number of second on that projectile thrown giving any of the players a chance to get the dropped projectile. After that number of seconds labeled on that projectile that hit that player is up, the player that dropped the projectile can now pick up the remaining projectile and rejoin the game.
(b) A method wherein at the end of a preset stop time all player add up the number on the ball they are holding and the highest number wins.
